(19) United States
(12) Patent Application Publication
(10) Pub. No.: US 2005/0055348 A1
(43) Pub. Date: Mar. 10, 2005

(54) XSteps: modular interface to a manufacturing control system

(76) Inventors: Sabine Deimel, Malschenberg (DE); Klaus Mildenberger, Mannheim (DE); Martin Schmidt, Wiesloch (DE); Christine Jaensch, Wiesloch (DE); Sabine Seelenmeyer, Ettlingen (DE); Matthias Schuler, Wiesloch (DE); Christoph Scheiber, Reilingen (DE)

Correspondence Address: KENYON & KENYON, 1500 K STREET, N.W., SUITE 700, WASHINGTON, DC, 20005, US

(21) Appl. No.: 10/739,132

(22) Filed: Dec. 19, 2003

Related U.S. Application Data
(60) Provisional application No. 60/500,239, filed on Sep. 5, 2003.

(51) Int. Cl. G06F 17/30; G06F 9/44

(52) U.S. Cl. 707/6; 707/7; 707/3; 717/163

(57) ABSTRACT

“XSteps” are modular data objects that model performance of various operations in a manufacturing process. Designers of manufacturing processes can build complex manufacturing systems from the modular XSteps and may enter parameter information that defines inputs to the corresponding XSteps. An XStep may include a parameter array defining different variables that determine behavior of the manufacturing operation represented by the XStep, a process instruction attribute that includes instructions to be delivered to automatic- or manually-driven manufacturing processes when the manufacturing operations are performed and an actuals attribute to capture manufacturing data as the manufacturing operations are performed. Thus, the present invention provides an integrated view into automatic, semi-automatic and manually-driven manufacturing processes.

This application benefits from the priority of provisional application Ser. No. 60/500,239, filed Sep. 5, 2003, the disclosure of which is incorporated herein.

### BACKGROUND

Many manufacturing processes often involve very complex execution steps, which are performed manually and/or automatically. SAP AG, the assignee of the present invention, designs and sells computer enterprise management systems (EMSs) that, among other things, permit manufacturers to design and model their manufacturing processes. Often, the manufacturing processes are quite complex. Complexity can arise from any of the following reasons:
master data maintenance for a wide variety of different processes, ingredients, products and product quantities, can lead to an exponential growing number of possible combinations,
manufacturers develop strong requirements regarding details of the process execution, to controlling, to reporting, to the sequence control of single process steps,
manufacturers require exception handling for automated and manually-driven processes and input validation for manually-driven processes,
manufacturers require synchronization and data exchange between business processes and their manufacturing processes based on events from different systems, which requires oversight to map data structures from one system to corresponding data structures in other systems, and
Manufacturers require an integrated view on manually-driven processes and fully or semi-automated processes.
   Many manufacturing processes, however, share similar execution steps. Particularly, within an organization that manufactures two or more similar products, productions of these products can involve nearly identical execution steps with minor deviations. In order to manufacture these products, however, each of manufacturing steps has to be repeated in a production run with very specific details. The data maintenance could be very time consuming and costly if complex manufacturing processes are involved in a large manufacturing plant. Moreover, it could be especially hard to control manufacturing processes if the products are manufactured in different locations. Thus, there is a need for an automated manufacturing control system and method for controlling a manufacturing system and method, which simplifies design and control of manufacturing processes, simplifies data management at interfaces among a manufacturing control layer and a process control layer and saves resources.

### BRIEF DESCRIPTION OF THE DRAWINGS

FIG. 1 is a functional diagram illustrating an embodiment of the present invention.

FIG. 2 illustrates an abstract view of an XStep module according to an embodiment of the present invention.

FIG. 3 illustrates an XStep tree structure populated with exemplary XSteps according to an embodiment of the present invention.

FIG. 4 illustrates a document chain based on XStep trees according to an embodiment of the present invention.

### DETAILED DESCRIPTION

Embodiments of the present invention provide a process design system that simplifies the labor required to design, model and simulate a large-scale manufacturing process. The design system is based on a modular data model for manufacturing processes, which the inventors call “XSteps.” XSteps provide many advantages over prior, manually-driven design system to manage and often reduce design complexities. For example:
XSteps can be used for master data maintenance as well as for transaction data maintenance to define steps of the manufacturing execution from the business processes point of view,
XSteps are organized in trees, they can be nested into each other and they can reference each other; as a result it is possible to define Standard XSteps (SXS) that are reused in different process descriptions, pretty simple steps as well as more complex steps,
XStep parameters are used to define a kind of data model, describing the data that need to be handled within different steps and what data to exchange between different steps,
XSteps provide concepts to link business object data and execution object data: XStep generation, automatic parameter valuation, application context assignment, activation filter, and LIVE-Parameters.

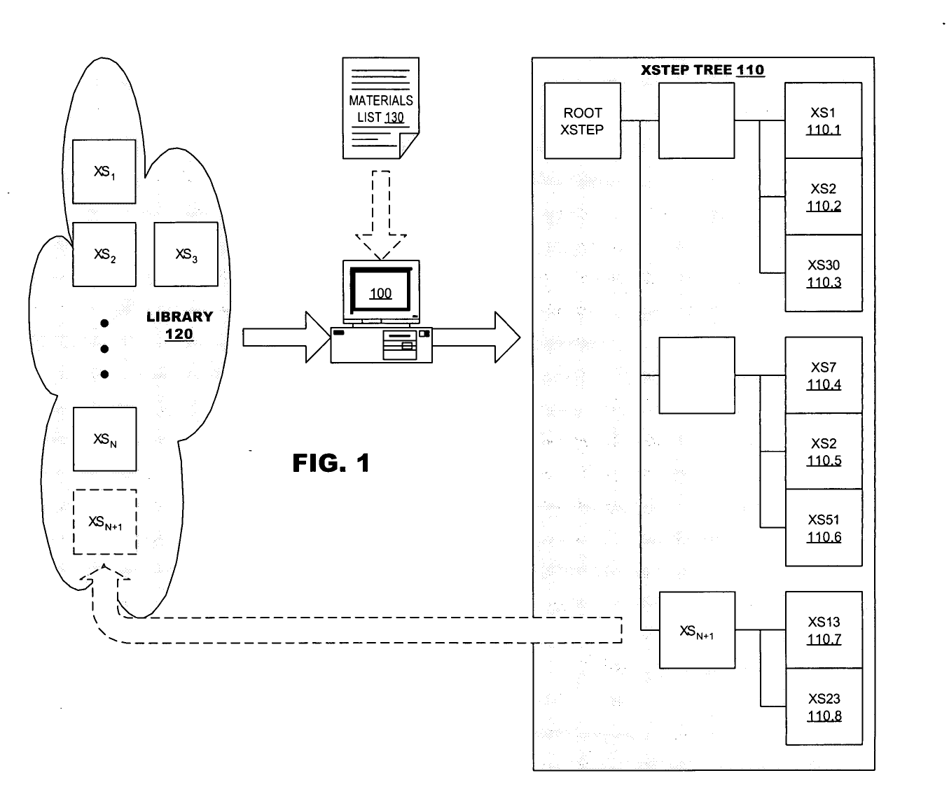

FIG. 1 is a functional diagram illustrating an embodiment of the present invention. There, an XStep editor 100 builds an XStep tree 110 to represent a manufacturing process to be performed. Components of the XStep tree 110 may be selected from modules (XS₁, XS₂ . . . XS_{N}) in an XStep repository 120 and added to the tree. For some of the XStep modules (say, XS₁), when they are added to the XStep tree 110, an operator at the editor 100 may enter data indicating how XStep module XS₁ is integrated with other XStep modules previously added to the tree. Thus, by incrementally building an XStep tree 110 from a plurality of pre-defined XStep modules and linking them, one may build a tree that models a manufacturing process for a product or other good.

In an embodiment, the XStep repository 120 may provide a number of Standard XStep modules (SXS) representing simple operations that can be performed in a variety of manufacturing operations. Over time, however, as an organization works with the XStep modules to define various trees, various segments of the XStep trees may find application for more than one of the organization's manufacturing operations. Accordingly, the XStep editor 100 permits an operator to select an XStep tree or portion thereof and to save it back to the XStep repository 120 (shown as XStep XS_{N+1}). In this way, the XStep repository 120 is permitted to grow over time to include XSteps that are custom-designed by the XStep editor 100 for re-use.

An XSteps repository 120 may be organized in any manner that is intuitive for those who work with the editor 100. Repositories can be organized based on folders, the Standard XSteps provided therein or XStep versions. Additionally, repositories can be organized based on plant resources and operations available for these resources, and of course based on the materials to be used in a manufacturing process.

In an embodiment, the editor 100 may generate portions of an XStep tree 110 automatically either by inserting individual XSteps or by building sub-trees within the tree. Several operations are available. In one alternative, an editor may insert XSteps or sub-trees based on an operator's history and based on application data. Moreover, the editor 100 may support a wizard to create XStep trees from queries made to an operator and the operator's responses thereto.

An XSteps editor 100 also may provide example lists, either public within a network or private to one or more operators. Conventional drag and drop or copy/paste functionality may support copying of XSteps between example lists and XStep trees.

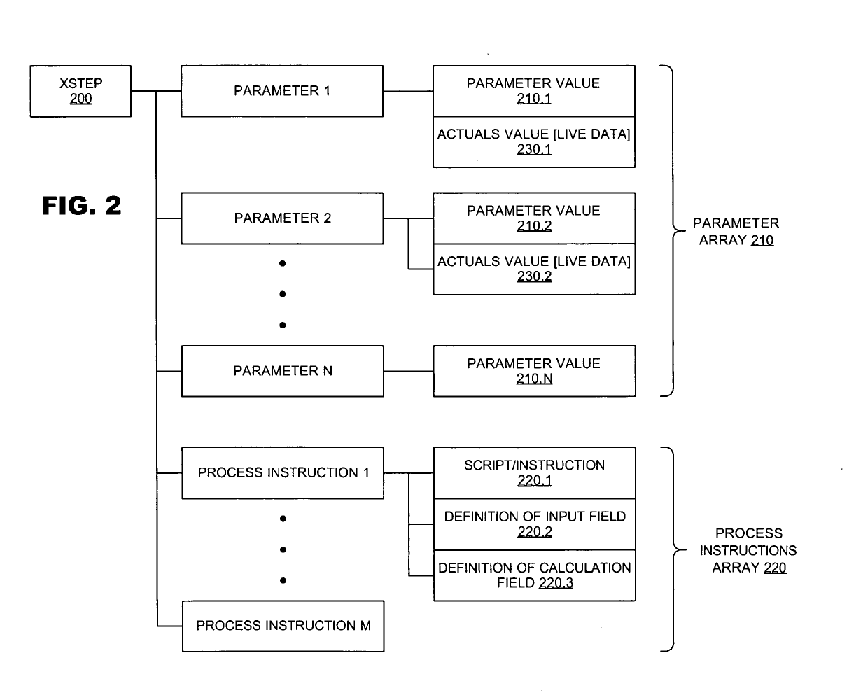

FIG. 2 illustrates an abstract view of an XStep module according to an embodiment of the present invention. An XStep is an object in a computer system that represents an incremental manufacturing operation in some process or assembly system. An XStep 200 may include several components, including a parameter array 210 and process instructions 220. As its name implies, the parameter array 210 may define a number of parameters that determine operation of the process represented by the XStep. For example, for an XStep representing a heating operation of a mixer or some other apparatus, the parameter array 210 may include parameters to define temperature and time. When deployed for use in an XStep tree 110 (FIG. 1), an operator may define values for these parameters that are suitable for the manufacturing process at hand (e.g., 120° C., 1 hr.).

The parameter array 210 is the basis of a data model to represent a manufacturing process. Parameters therein are unique objects; each one is assigned to an XStep. Each parameter may have several attributes, including the parameter's name, its technical type, semantic type, valuation mode and value among others. The parameters also can be used to define data exchange between the XStep and other XSteps in the XStep tree 110.

The process instructions array 220 of an XStep 200 may include process instructions, control information to be passed to automated process equipment or human operators in a manufacturing process. Conventionally, automated process equipment operates according to scripts, commands that the equipment can interpret and implement according to its own procedures. For manually executed processes, associated computer hardware may prompt human operators with a series of instructions identifying operations that are to be performed at each manufacturing stage. Thus, one or more control scripts or messages 220.1 may be developed from the parameter values entered when an XStep 200 is added to an XStep tree 110. These scripts/messages may be included in the process instructions attribute 220.

In an embodiment, process instructions may follow a generic data format for destination-specific content. For example, the process instructions may be defined according to a sorted name-value-list where value types include: date, time, timestamp, numeric value, character sequence, Uniform Resource Identifiers (“URIs”), binary data or text (XML, HTML, PDF, ASCII and others). The destination object, the automated apparatus or an operator interface, may interpret the content according to its own logic.

Additionally, the process instruction array 220 may include fields defining input data 220.2 and calculation data 220.3. When interactive documents are created from an XStep tree, operators of manually driven processes may enter data into the interactive documents. Further operation of a manufacturing process may be performed in response to the input data (at field 220.2) and to any calculations that may be defined at field 220.3.

An XStep 200 also may include an “actuals” attribute (shown as 230.1, 230.2, etc.) for entry of values that are used when the manufacturing process represented by the XStep tree 110 (FIG. 1) is performed. The actuals attribute 230 may capture values that actually are used in a particular manufactured batch. For example, if a manufacturing process calls for 25 kg of some substance to be used but 25.1 kg were used in a particular batch, the value 25.1 would be captured in the actuals attribute 230. XSteps also may specify which actuals values are to be returned to the manufacturing control layer as LIVE data.

In an embodiment, the actual values component becomes effective when the process represented by the XSteps tree 110 is performed. As discussed below, an XSteps tree 110 may serve as the foundation of a one or more PI sheets. The PI sheet may be an interactive document where, when the corresponding processes actually are performed, values representing actual process values are entered. Thus, in the foregoing example where a heating step is specified to occur at 650° F. for 2 hours, during a run of the process, it may occur that that heating actually was performed at 647° F. for 2 hours, 5 minutes. Such values may be recorded in the actuals fields 230 of the PI sheet.

FIG. 2 illustrates various attributes that occur through the “lifecycle” of an XStep 200. These attributes, however, need not persist through all phases of the XStep's lifecycle. For example, when an XStep is present in -the XStep repository 120 (FIG. 1), the parameters attribute 210 may be only partially defined. Using the heating example provided above, the parameters attribute may define that temperature and time parameters are relevant for this XStep but, of course, specific values of time and temperature are not defined until the XStep 200 is integrated into an XStep tree 110. Similarly, the XStep 200 may include general control scripts or message but may not have other process instructions 220 fully defined. In one embodiment, an XStep 200 need not include an actuals attribute 230 when present in the repository 120; the attribute can be added to the XStep 200 when it is added to the XStep tree 110 or even later when the XStep tree 110 is transferred from an editor to a processing system for use in an actual manufacturing system.

Returning to FIG. 1, an XStep tree 110 also can support context assignment in an embodiment of the present invention. Context nodes are nodes within an XStep tree that represent logical parts of an application object that owns the XStep tree 110. When a context node is inserted into an XStep tree, portions of the tree subordinate to the context node, a sub-tree starting at the insertion point, is assigned to the given context. For example, one sub-tree could be assigned to an operation designated “A”, another sub-tree can be assigned to another operation (“B”) and an additional sub-tree can be assigned to the whole production order/run. The context assignment can be overwritten at any XStep in the XStep tree.

A context of a production order may influence the generation of XSteps and the automatic valuation of XStep Parameters. Assume, for example, that an operation A requires material M1 and M2 as input materials and operation B requires material M3 and M4. If the generation “For all input materials” is executed only in the context of operation A, the materials M1 and M2 would be taken into account. If the same generation scope is used only in the context of operation B, the template step would be performed for the materials M3 and M4. In the context of the whole production order/run the generation would repeat the template step for materials M1, M2, M3 and M4.

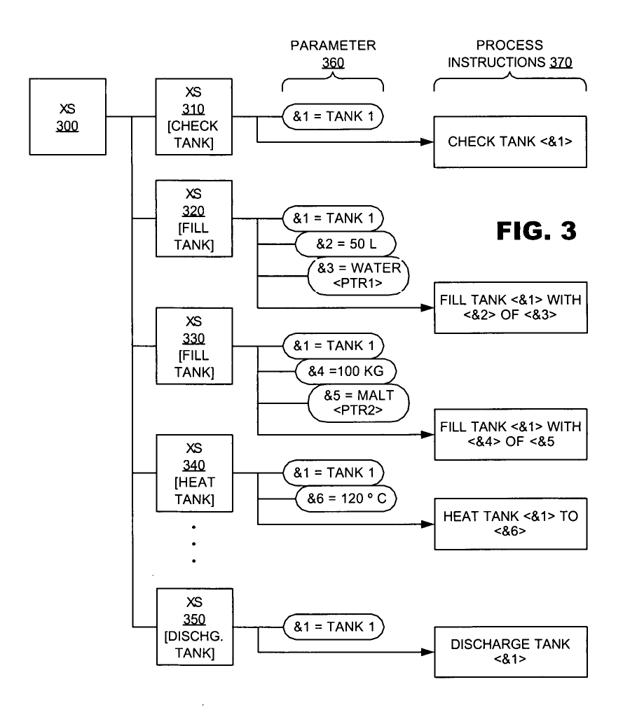

FIG. 3 illustrates an exemplary XStep tree according to an embodiment of the invention. As illustrated, the XStep tree may include a root XSteps 300 and at least five subordinate XSteps 310-350. In this example, the process may cover a sequence of operations to be performed with one of a plurality of available mixing tanks, called “Tank 1.” Parameter attributes 360 and process instructions 370 attributes are illustrated for this exemplary process. A first XStep 310 simply may initialize Tank 1 and may confirm that it is functioning properly. Second and third XSteps 320, 330 may cause the tank to be filled with 50 L of water and 100 kg of malt respectively. The fourth XStep 340 may cause Tank 1 to be heated to 120° C. A final XStep 350 may cause Tank 1 to discharge, presumably to some other apparatus. Although the XSteps of FIG. 3 are illustrated in sequence order, it need not be the case; alternatively, an XStep tree 300 may include a statement that defines an order of processing among XSteps.

XSteps also may support data exchange among XSteps of different trees using parameters. For example, an application may own more than one XStep tree, (e.g. a tree for each operation of a production run). In this case data from one XStep tree may propagate to another XStep tree. The data exchange between two or more XStep trees may be based on parameters of the root nodes in the tree. The data exchange can be defined manually or can be established automatically by the system by comparing different application context nodes assigned to the root nodes, comparing the dependencies between the different application context nodes and finally comparing the valuation symbols of root parameters.

In this simplified view, the XStep's parameters attributes 360 provide values that define operation of the generic filling and heating steps that can be performed for a mixer. These values tailor operation of the mixer to a specific task. The parameter values also can be interlinked with other XSteps from other process stages if applicable, using reference pointers to the other XSteps. For example, if the water were an output from some other process stage (such as a water purifier or the like), the parameter values may include pointers to those others XSteps. These are shown in FIG. 3 as values <PTR₁> and <PTR₂>.

In another embodiment, parameter attributes 360 may be defined to permit automatic parameter valuation at runtime rather than at a time the XStep tree 300 is defined. In this embodiment (not shown), a select number of parameter attributes may be defined to be base units of measure for the manufacturing processing being represented. Then, other parameter attributes may be defined by valuation symbols, which provide a relationship with one or more base units of measure.

Consider the example of paragraph [22] above. If the generation “For all input materials” is assigned, then XSteps that are repeated for each input material should have parameters for e.g. material, quantity, unit of measure and batch. Within master data maintenance an operator can define parameters P1, P2, P3 and P4. A technical type and a semantic type (the valuation symbol) can be assigned to each parameter. Assume for example that P1 gets the semantic type SAP:MATERIAL, P2 gets SAP:QUANTITY, P3 gets SAP:UOM and P4 gets SAP:BATCH. While the generation is executed, the template XStep may be repeated “For each input material” and each copy provides the same parameters. Each copy, however, will get different values for each parameter, e.g. P1 of the first copy gets material M1 and P1 of the second copy gets material M2. The automatic valuation checks parameters for the semantic type and queries missing data from other applications.

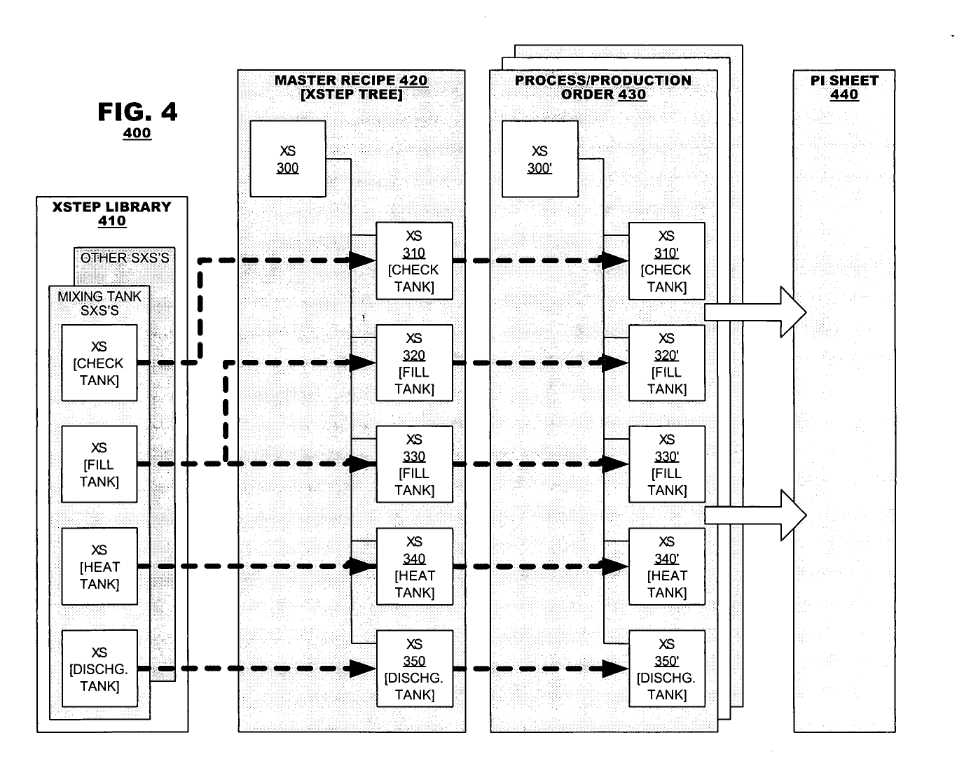

Returning to FIG. 1, the XSteps editor 100 is a tool that permits operators to build and maintain XStep trees 110. The XStep trees 110 become the basis of documents that can be used by a Manufacturing Execution System (MES) to control the manufacturing process itself. FIG. 4 illustrates evolution of an XStep tree according to an embodiment of the present invention. As noted, an XStep tree 420 may be constructed from a repository 410 of standard XSteps by virtue of the editor 100 (FIG. 1). Again, during this process, the editor 100 may generate information linking the various XSteps to each other, defining parameter values that are to be used for each XStep and, as necessary, simulating performance of the XSteps in the tree 420. When the XStep tree 410 is completed, it may be considered a “master recipe” representing the manufacturing process for some product or good and it may be released to the MES. When this occurs, the editor 100 resolves any references that may persist between the XSteps within the tree 420 and source XSteps in the repository 410. Essentially, the XSteps in the tree 420 become standalone objects that maintain their integrity when released from the editor 100.

Alternatively, references may be resolved when a production order is created or a production run is started. This can be advantageous because any updates to XSteps may be included in the production order/run.

When the tree is released as a master recipe 420, it may become the basis of a process order document or a production order document (collectively, “PO document”) 430. Conventionally, within MES systems, PO documents are used to manage the manufacture and tracking of products. Among other things, the PO documents have utility in warehouse systems to track the creation of or consumption of inventory (as occurs when products are manufactured from component parts). Thus, a PO document may cause a manufacturing process to be performed; the manufacturing process may be represented by a master recipe based on XSteps. According to an embodiment, therefore, an XStep tree from a master recipe document 420 may be copied to a PO document 430 (copied XSteps are shown as 300′, 310′, etc.). A master recipe 420 may generate multiple PO documents 430. When the manufacturing process is performed in a manufacturing plant, the PO document 430 may become the source of a Process Instruction (PI) sheet 440, an interactive document that captures manufacturing actuals data obtained during product manufacture. Scripts from the PI sheet 440 may be delivered to automated control apparatus and process control instructions may be delivered to plant operators. The actuals data may be captured from control points within the manufacturing process, again both automated and manual elements therein, and maintained in the PI sheet.

Returning to FIG. 1, the XSteps editor 100 also may provide a mechanism for exception control in a manufacturing process. As described below, an XStep tree can become the foundation of a interactive PI sheet or other document that allows manual data input and performs local input validation and exception handling. For example, if an operator attempts to input a value for a variable that it outside a predetermined tolerance range, the input may not be accepted or may be accepted only with a comment or a digital signature from the operator. Alternatively, when a process is running and some deviation occurs (e.g. one that affects product quality), the XStep trees may specify that processes represented by additional XSteps are be performed or that processes represented by other XSteps be deactivated or delayed. Further, some XSteps may cause certain conditions within the manufacturing process to be tested and, in response thereto, trigger alarms and/or cause some alternative action to be performed. An XStep may include an activation filter that specifies conditions that must occur for the XStep process to be performed. The activation filter may include an activation formula, the results of which are compared to some threshold to determine whether the XStep should be performed. Accordingly, the XSteps can be activated dynamically and can permit branches to occur in a manufacturing process.

The XSteps editor 100 also may provide a component for simulation and testing of a manufacturing process built from XSteps. When an XStep tree 110 is either partially or completely complete, an operator can cause the editor 100 to develop a test PI document therefrom. The operator may cause test actuals data to be entered into the PI document to test the tree's response and to confirm that error conditions are handled adequately. In so doing, the editor 100 may interpret control scripts generated from the process instruction attributes 220 of the various XSteps and either query the operator directly for values to enter in response or read test values from a test interface document. In this way, the editor 100 provides a mechanism through which an operator can fully test and de-bug an XStep tree 110 before it is released for use as a master recipe.

In another embodiment, the XSteps editor 100 may populate certain parameters fields automatically from a materials list 130 presented to it from an external source. Materials lists 130 are commonly used in a variety of different manufacturing contexts; they typically describe either parts or material components that are to be used to manufacture a predetermined product or good. During the course of building an XSteps tree 110, an editor 100 may survey a materials list 130 to determine whether the list 130 identifies component elements that fit the parameters attributes of the XSteps already provided in the tree 110. Matches may be identified based on matches between the parameters' names, technical or semantic types or other values defined for the parameter. If so, the editor 100 may define parameter values in an automated fashion, using the values of the materials list 130 as a reference. In this way, the XSteps editor 100 can reduce the amount of data entry required by an operator.

As discussed above, XSteps can be used for master data maintenance as well as for transaction data maintenance (e.g., defining manufacturing processes). The principles of the XStep trees can be assigned to almost any application object. Master data typically are used to pre-define transactional data objects that will be created later, e.g. for each production run. For example, bills of materials often are pre-defined without a prior determination of what an actual product quantity will be, but knowing relative quantities of some ingredients given a target product quantity for a production run. Similarly, operations and phases can be pre-defined as part of master data, e.g. as part of a master recipe. One master recipe could be used for e.g. production runs with a product quantity between 100 and 1000 kg, one other for a quantity between 1000 kg and 2000 kg. An actual quantity is given later when specific production runs are prepared and when resources are selected.

Master data typically are maintained using versioning or referring to change dates/numbers in order to make sure that the changes will only take effect from a specific date. Similarly, traditional XSteps may include version numbers, change numbers and effective dates to manage use of the XSteps in various editors. Additionally, the simulation and testing features described above also can be applied to master data prior to releasing it for productive use.

XSteps can be used for master data maintenance as well as for transaction data maintenance, because:
XSteps support different change methods (non-historical, versioning, historical changes based on change numbers or change dates),
XSteps define a data structure that can be assigned to any master data object as well as to any transactional data object,
XSteps support valuation symbols, generation and application context assignment to pre-define a data handling where actual data are still missing,
XSteps support a simulation of master data or transactional data at any time, providing an integrated view on different destination objects (types),
XSteps support a generic reference mechanism; references can be defined e.g. in the master data environment and can be resolved as late as possible, e.g. when a production run is started.

Several embodiments of the present invention are specifically illustrated and described herein. However, it will be appreciated that modifications and variations of the present invention are covered by the above teachings and within the purview of the appended claims without departing from the spirit and intended scope of the invention.

1. A method of developing a manufacturing process control document, comprising:
selecting a plurality of modular data objects from library of the same, each data object representing an incremental manufacturing step, and
populating parameter arrays of the selected data objects to define interrelationships among them and to identify parameter data to be applied to the corresponding manufacturing step.

2. The method of claim 1, wherein at least one data object includes a script to control operation of an automated manufacturing apparatus.

3. The method of claim 1, wherein at least one data object includes process control messages to govern operation of a manually-driven manufacturing process corresponding to the data object.

4. The method of claim 1, wherein the data objects include an actuals attribute to capture data values representing parameter values actually obtained during a process run of the manufacturing process control document.

5. The method of claim 1, wherein the -populating comprises comparing data from a materials list to the parameter arrays of the selected data objects and, if the comparison identifies a match, defining values of the parameter array from matching entries of the materials list.

6. The method of claim 1, further comprising generating a master recipe document from the selected data objects.

7. A manufacturing design system, comprising:
computer storage having stored thereon modular data objects representing incremental manufacturing operations,
a computer system having an editor application executing thereon, the editor permitting an operator to select data objects from storage and integrate them into a data structure representing a manufacturing process.

8. The manufacturing design system of claim 7, wherein the editor permits an operator to select a collection of data objects from the data structure and save them to storage.

9. The manufacturing design system of claim 7, wherein the modular data objects comprise a parameter array having attributes that define the operation of the manufacturing operation corresponding thereto

10. The manufacturing design system of claim 7, wherein the modular data objects comprise a process instruction attribute having stored therein scripts that control operation of an automated process equipment corresponding to the manufacturing operation.

11. The manufacturing design system of claim 7, wherein the modular data objects comprise a process instruction attribute having stored therein process instructions that specify a manual process to be performed corresponding to the manufacturing operation.

12. The manufacturing design system of claim 7, wherein the modular data objects comprise an actuals attribute for capture of parameter values used during a manufacturing operation corresponding to parameters of the parameter array.

13. The manufacturing design system of claim 7, wherein the editor comprises a simulator to test the manufacturing process represented by the data structure.

14. The manufacturing design system of claim 7, wherein the editor generates a master recipe document represented by the data structure.

15. Computer readable medium storing program instructions that, when executed, cause an editor application to:
select modular data objects representing incremental manufacturing operations from a library of the same under operator control,
integrate the selected data objects into a data structure according to parameter data for each of the selected data objects, and
generate a master recipe document based on the data structure when the data structure is complete.

16. The computer readable medium of claim 15, wherein the data objects comprise:
a parameter array having variable defined therein that define operation of the corresponding manufacturing operation,
a process instruction field including instructions for performing the corresponding manufacturing operation, and
an actuals field to capture manufacturing performance data values corresponding to the variables of the parameter array.

17. The computer readable medium of claim 15, wherein the editor application populates parameter data from an externally-supplied materials list.

18. The computer readable medium of claim 15, wherein the editor application populates parameter data according to operator input.

19. The computer readable medium of claim 15, wherein the editor application populates parameter data of at least one data object with a pointer to another object.

20. The computer readable medium of claim 15, wherein the program instructions further cause a PO document to be generated from the master recipe document.
